(19) United States
(12) Patent Application Publication
(10) Pub. No.: US 2011/0211339 A1
(43) Pub. Date: Sep. 1, 2011

(54) LIGHT EMITTER DIODE MODULE

(75) Inventors: Shu-Kai HUNG, Tucheng city (TW); Chung-Yi VEI, Tucheng city (TW)

(73) Assignee: QING RONG TECHNOLOGY INC., Tucheng City (TW)

(21) Appl. No.: 12/713,198

(22) Filed: Feb. 26, 2010

(51) Int. Cl. F21L 4/02; F21V 1/00

(52) U.S. Cl. 362/184; 362/235

(57) ABSTRACT

A light emitting diode module is disclosed. The supporter is a metal frame, which are punched to form a power frame, a first ground frame, a second ground frame, a plurality of first sub-carriers, and a plurality of second sub-carriers. A resistor is seated on a pair of resistor seats which is respectively on the first ground frame and the second ground frame. The light emitting diode module comprises a plurality of first LED groups connected in parallel and the LED chips in each first LED group are connected in series. The LED module can also be modified to become an AC type LED module by having a plurality of second LED chips with LED chips in series but at a reversal direction against the LED chips in the first LED group.

### BACKGROUND OF THE INVENTION

(1) Field of the Invention

The invention relates to a light emitter diode module, in particularly, to the emitter diode module based on a metal frame having a pattern as a circuitry as a carrier.

(2) Description of the Prior Art

The light emitter diode (LED) is known to have the properties of light beam condensed and directive but low luminous flux for a single LED. Thus, a LED lamp contains in general not just a single LED chip but with several LED chips together. Before blue light LED invention, the LED lamp is usually served as signal light, decorated light, tail light and/or headlight of a car. With the invention of blue light LED and the price of the LED steep fallen, all of them provide the white light LED with more platforms. For instance, the white light LED lamp is found to have the potential to substitute the conventional incandescent lamps and served as light source of the liquid crystal display.

In particularly, with the environment gradually toward global warming nowadays, energy saving and carbon dioxide reduce become a common consensus for almost all of nation's governments on earth. It is thus anticipated that the white light LED lamp will become main stream to substitute the incandescent lamps in the near future. The principle of light emitting is distinct from the incandescent lamps, which rely on heating the tungsten filaments. The LED lamp used the principle of electron and hole recombination in the intrinsic layer after current injection. Nevertheless, those of high brightness of the LED lamps with power over one watt are found to have consumed a portion of energy in a form of heat still. Hence the heat dissipation problem of the LED is still demanded to overcome. A LED lamp with appropriate heat dissipation is not only a power saving apparatus but also have a very long life time comparing with the incandescent lamps by over several tens thousand hours versus several hounds of hours.

In general even for the high brightness LED chip, it is still with power less than 3˜5 watt whose lumen is not enough to provide as indoor illumination. It is thus a LED apparatus usually constituted of ten to twenty of LED chips and arranged as a square array or in a ring. In particularly, to save the housing space, the LED chips may be crowded in a small space, result in bad heat dissipation. The situation may be further worse by using a lamp cover.

Like most of the electronic appliance, the current injection for light emitting cause temperature soar rapidly, resulted in premature decay if the current does not further constrained. The LED has a limited power, the heat dissipation may be one of a major factor. Consequently, most of the indoor-illuminate use LED apparatus, the LED-chips packaged on a print circuit board are usually mounted on a metal board or as a metal surmount and then mounted with a heat dissipation module with heat dissipation paste therebetween. Generally, a LED apparatus contains no electric fan but with heat fins modules so as to save power and avoid noise.

Generally, LED for illumination is used usually packaged with multi-chips with a reflector or one LED chip with one reflector surrounded and mounted on a print circuit board so as to increase the lumen. An example is shown in FIG. 1, which shows a LED apparatus 10 like a flash-light head. A plurality of LED chips 12 are surrounded with a reflector 15, packaged, and mounted on a PCB 17 having circuit (not shown) and two leads 20 through a circle metal plate 25. The heat dissipation capability of the LED apparatus is bad though it seems with a large area, the metal plate 25, to dissipate the heat. One of reason is that so many LED chips are packed in the bottom of the reflector which is a small area. Apart from that the two leads 20 are isolated with the metal plate 25 and the PCB is also isolated with the metal plate 25 thus it provides only limited heat sink. Thus the temperature of LED apparatus is expected to be increased and caused the LED cheap decay after a short term aging.

Another prior art shown is the LED chips disposed on a PCB. The PCB has a copper foil about 0.01 mm in thickness etched to form a circuit for LED chips in series and/or in parallel connected thereon. The interval between LED chips must be large enough to avoid over heat. The features of the prior art is the reflectors formed by injection molding on a lead frame and then striped off and then remounted on the PCB.

The LED module formed procedures according to the forgoing prior art are rather complication and thus it is unfavorable to cost reduction.

An object of the present invention is thus to provide a LED module with low cost to form. The supporter is the metal frame which is also a frame for reflectors formed by a technique of injection molding. It is thus can cost down.

### SUMMARY OF THE INVENTION

A light emitting diode module is disclosed. The supporter is a metal frame, which are punched to form a power frame, a first ground frame, a second ground frame, a plurality of first sub-carriers, and a plurality of second sub-carriers. A resistor is seated on a pair of resistor seats which is respectively on the first ground frame and the second ground frame. The light emitting diode module comprises a plurality of first LED groups connected in parallel and the LED chips in each first LED group are connected in series. The LED module can also be modified to become an AC type LED module by having a plurality of second LED chips with LED chips in series but at a reversal direction against the LED chips in the first LED group.

### BRIEF DESCRIPTION OF THE DRAWINGS

The present invention will now be specified with reference to its preferred embodiment illustrated in the drawings, in which:

FIG. 1 is a light emitting lamp in accordance with the prior art;

FIG. 2 is a light emitting module based on a print circuit in accordance with the prior art;

FIG. 3 is a metal frame provided as a support of the LED module in accordance with the present invention;

FIG. 4a is a LED module sample before fixed by a plate in accordance with the present invention;

FIG. 4b is a side view of a resistor seated on the metal frame in accordance with the present invention; and

FIG. 5 is a LED module in accordance with the present invention;

FIG. 6 is a second preferred embodiment of LED module in accordance with the present invention;

FIG. 7 is a third preferred embodiment of LED module in accordance with the present invention.

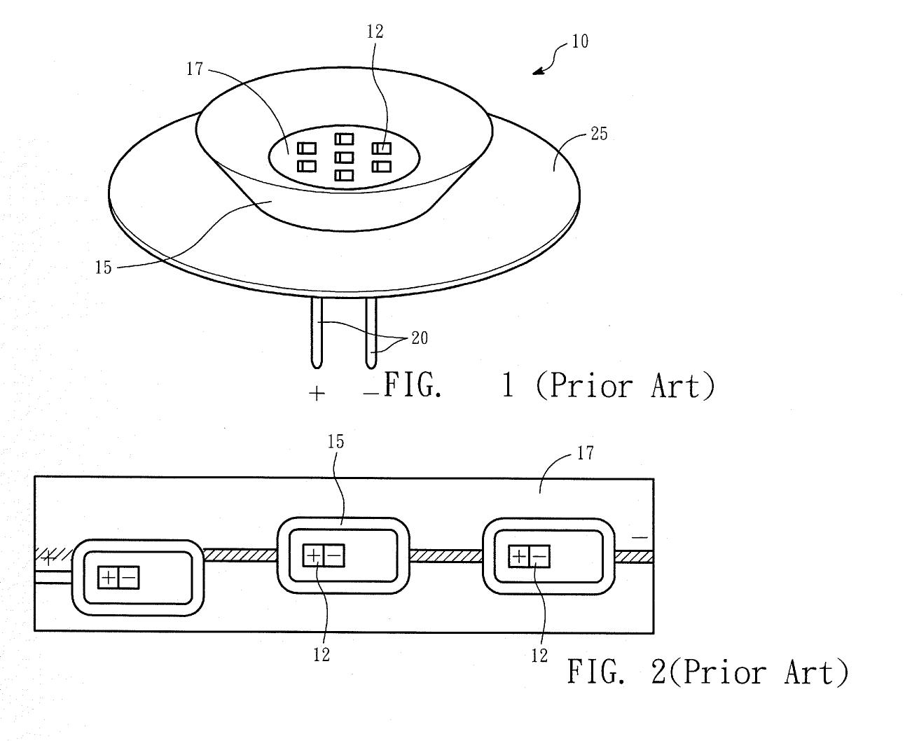

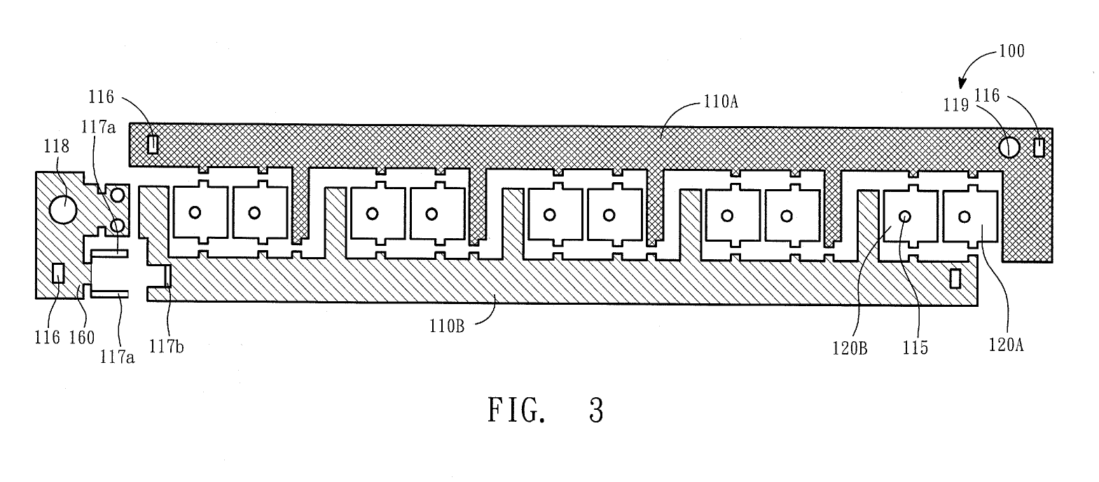

### DESCRIPTION OF THE PREFERRED EMBODIMENT

The process for forming the LED module in accordance with the aforementioned prior art at least including injection modeling the reflectors on a metal frame. The reflectors are then stripped off individually and then mounted them on a PCB board again, which formed with a print circuit or disposed on a metal supporter but with an insulting layer thereon formed to isolate the two electrodes of the LED. No matter the PCB or the metal supporter with an isolating layer formed therebetween, both assemble structures are unfavorable for heat dissipation.

Referring to FIG. 3, a schematic diagram of a metal frame 100 is shown. The metal frame 100 is punched from a raw metal belt shown, which includes a power frame 110A having two positioning holes 116, a first ground frame 110B having a positioning hole 116, a second ground frame 160, a plurality of first sub-carrier 120A having a locating hole 115 each, a plurality of second sub-carrier 120B having a, locating hole 115 too, a pair of resistor seats 117a and 117b, punch locating holes 118, 119. The first ground frame 110B having a first part of a resistor seat 117b is separated from the second ground frame having a second part of the resistor seat 117a. The resistor seat 117a is formed by folding two pieces metal of metal frame 100 up and the resistor seat 117b is formed by folding one piece metal of metal frame up All of above parts are prepared by pre-punching a raw metal belt. Hence, after injection modeling the reflectors, the power connected frame 110A and the ground connected frame 110B are easily separated therefrom. No extra wire or a print circuit is necessary. The locating holes 115 are provided for metal prime belt to locate. The positioning holes 116 and punch locating holes 118, 119 can also be provided as connecting bridges for the present LED module with the other.

According to an preferred embodiment of the present invention, the metal frame is made of copper, or copper alloy such as brass, bronze, aluminum, or aluminum alloy, which are characteristic with good heat conductivity and electric conductivity. The metal frame 100 has a thickness between about 0.1 mm to 0.3 mm so as to provide heat and electric conductivity and supporter strength. The punch locating holes 118,119 provided for locating the metal belt while punching and connecting in either power of ground lead frame.

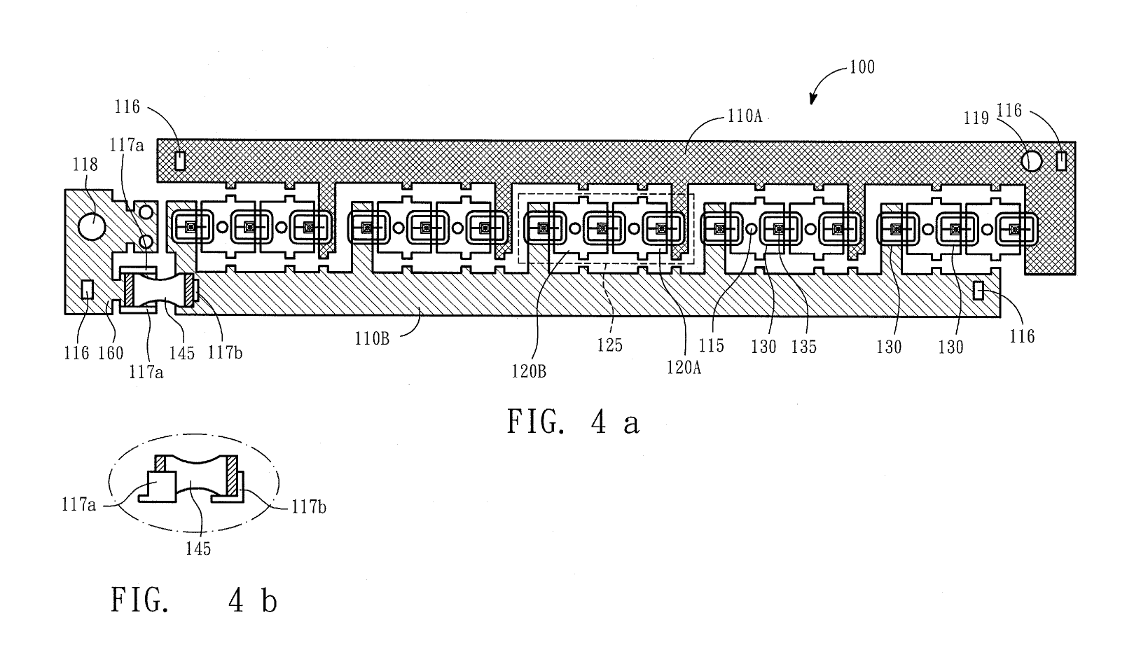

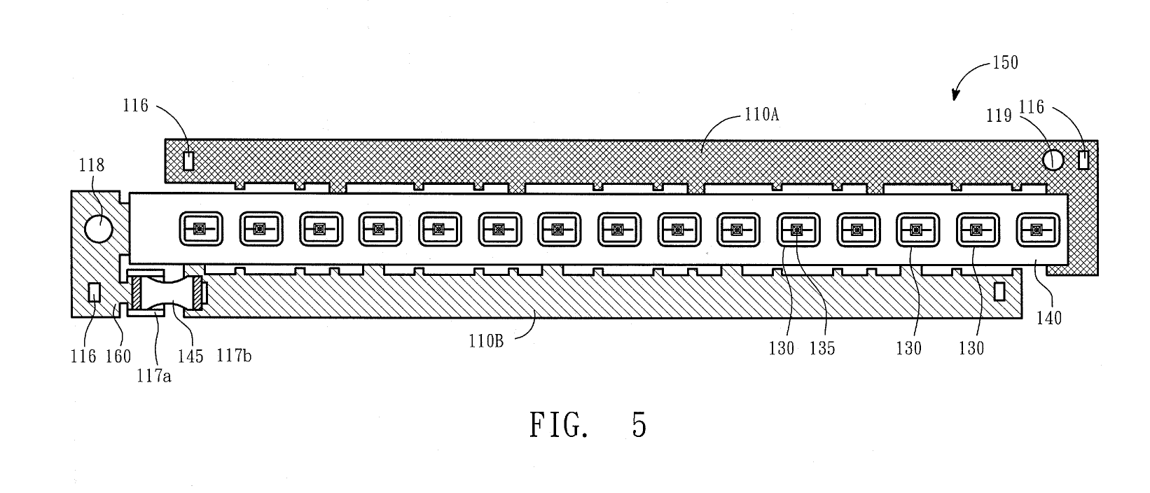

The pair of resistor seat 117a and 117b is formed by punching and then folding, as is shown in FIG. 4B.

As shown in FIG. 4a, the metal frame 100 is provided for supporting reflectors by ejecting. For every two sub-carriers, there are three reflectors 130 are respectively, formed, across the power source frame and the first sub-carrier 120A, the first sub-carrier 120A and the second sub-carrier 120B, and the second sub-carrier 120B and the ground frame 110B.

Preferably, each reflector is provided for housing one LED chip. Thus three LED chips are connected in series to constitute a first group 125. The group combination herein is in response to the power supply specification popularly, which is 12V (>(3.7V×3) in the current market. Thus it does not intend to limit other permutation. In addition, the resistor is disposed on the resistor seat 117a,117b without lead but has contact pads at two ends contacted with the resistor seat 117a,117b instead. The pair of the resistor seats 117a,117b locates respectively, at power frame 110A and ground frame 110B. The resistor 145 is to share a portion of voltage so as to protect the LED chips from over-current, as is shown in FIG. 4B. The LED mounted may be a chip flipped (with two electrodes at the same side), or without (two electrodes at different sides, which a wire is needed).

To increase the luminance, more LED chips are necessary either in series or in parallel or both. For example, the LED module shown includes three first groups 125 in parallel connected. In the preferred embodiment no print circuit is necessary. The LED module may further be coupled with one or more LED modules by locating holes 118,119 connection.

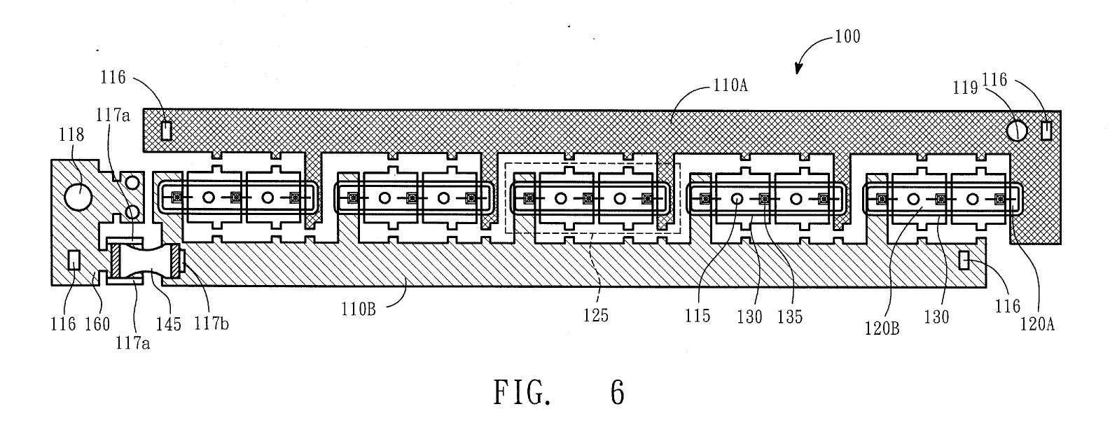

Referring to FIG. 5, a rectangular insulating board 140 is formed on the first sub-carrier 120A, and the second sub-carrier 120B, fasten them to the power frame 110A, and the ground frame 110B as a package.

In a test sample, the module have five first groups (15 LED chips) with a size 60 mm×12 mm and is supplied with 12V power adaptor, and 0.34 A in current without using any heat dissipation sink sustain for 300 hours, the temperature of the welding point LED chips are found still lower than 60° C.

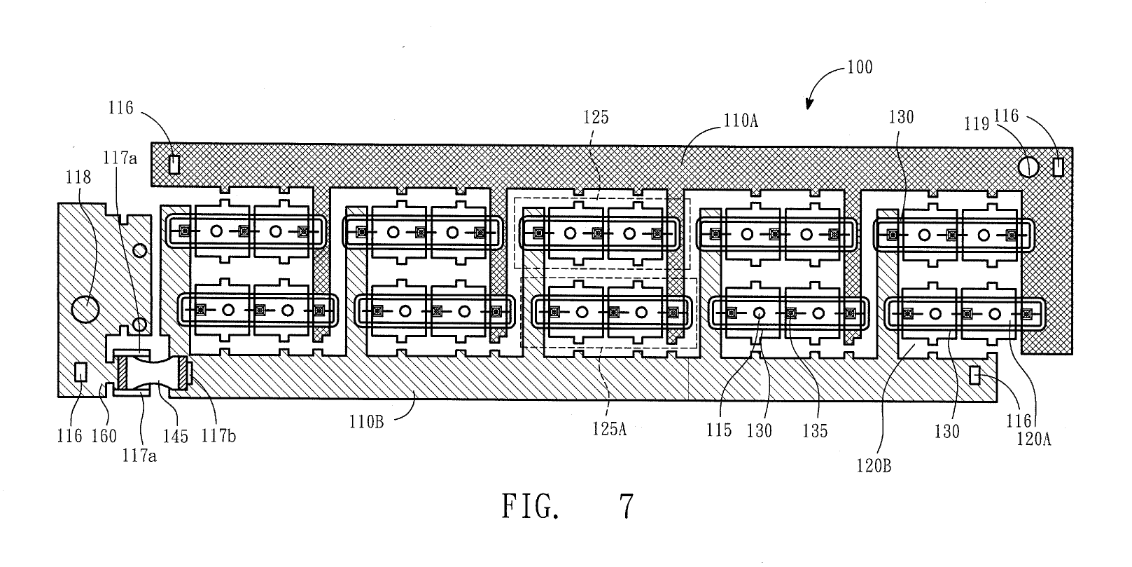

According to a second preferred embodiment, each first group has one reflector, as shown in FIG. 6. In comparison with the first preferred embodiment, the second embodiment is capable of further cost down in manufacture.

According to a third preferred embodiment, the LED module 200 Is provided for a power of alternative current (AC) type. Referring to FIG. 7, the LED module shown includes three first groups 125 in parallel connected and three second groups 125A in parallel connected. The LED chips are in series connected in the first groups 125 but have a reversal direction against the second groups 125A. As foresaid first preferred embodiment, a reflector may just housing one LED chip.

The benefit of the present invention are:

(1) the supporter of the LED module is a metal frame with using any print circuit or wires (if the LED chips is flipped.

(2) the meter frame is also a supporter of the reflectors by injecting modeling and thus can save the cost for mounted the reflectors.

(3) The LED module is easy connected with another LED modules.

(4) the LED module can be a DC type or AC type.

While the present invention has been particularly shown and described with reference to a preferred embodiment, it will be understood by those skilled in the art that various changes in form and detail may be without departing from the spirit and scope of the present invention.

What is claimed is:

1. A light emitting diode module, comprising:
a plurality of light emitting diodes;
a metal frame having a pattern and served as a carrier of a plurality of first LED groups, said first LED groups electrical connected in parallel through said pattern wherein each of said first LED group has light emitting diodes in series connected and has at least one reflector for housing said light emitting diodes through said pattern thereof.

2. The light emitting module according to claim 1 wherein said pattern comprises a power frame, a ground frame, a plurality of sub-carrier plates.

3. The light emitting module according to claim 2 wherein said pattern is formed by punching said metal frame, which further comprises a pair of resistor seats which has one part connected with said power frame and the other connected with said ground frame.

4. The light emitting module according to claim 3 further comprising a resistor seated on said pair of resistor seats wherein said resistor haven't two leads on at two ends thereof but two pads instead.

5. The light emitting module according to claim 1 wherein each of said first LED groups comprises two sub-carriers for three LED chips.

6. The light emitting module according to claim 1 wherein said metal frame is provided for said reflectors formed directly thereon by injection modeling.

7. The light emitting module according to claim 1 further comprises an electrical insulating board to fix said sub-carrier plates to said power frame and said ground frame.

8. The light emitting module according to claim 1 further comprises two holes respectively formed at said power frame and said ground frame for said light emitting diode module connected with a DC power supply or a second of said light emitting diode module.

9. The light emitting module according to claim 1 further comprises a plurality of second LED groups and the LED chips are in series connected in said LED groups but having a reversal direction against said LED chips in said first LED groups so as to formed an AC type light emitting module.

10. The light emitting module according to claim 1 wherein said metal frame is selected one from a group consisting of alumina, alumina alloy, copper, and copper alloy.

11. A light emitting diode module, comprising:
a plurality of light emitting diodes;
a metal frame having a pattern having a power frame, a ground frame, a plurality of sub-carrier plates and said pattern served as a carrier for a plurality of first LED groups, said first LED groups electrical connected in parallel through said pattern wherein each of said first group has at least one reflector for housing said light emitting diodes electrical connected in series through said pattern therein;
a resistor seat formed by said metal frame and one part at said power frame and the other at said power frame;
a resistor seated on said resistor seat;
an insulating fixed board mounted on said pattern.
